(19) United States
(12) Patent Application Publication
(10) Pub. No.: US 2011/0066480 A1
(43) Pub. Date: Mar. 17, 2011

(54) METHOD, APPARATUS AND SYSTEM FOR EVENT-BASED CONTENT DISTRIBUTION AND DISPLAY

(76) Inventors: Gregory Charles Herlein, San Francisco, CA (US); Scott Arthur Lehman, Foster City, CA (US); Jeff Hollar, Livermore, CA (US)

(21) Appl. No.: 12/736,712

(22) PCT Filed: May 1, 2009
(86) PCT No.: PCT/US2009/002713

§ 371 Date: Nov. 1, 2010

(30) Foreign Application Priority Data
May 1, 2008 (US) 61/126101

(51) Int. Cl. G06Q 30/00

(52) U.S. Cl. 705/14.5

(57) ABSTRACT

In various embodiments of the present invention, the determination of what content to distribute or play is determined by a set of triggers (events) and rules for processing the triggers. The rules are simple and actionable and the triggers are clear and unambiguous and relate directly to the rules. In such embodiments, a schedule can be accomplished by following the trigger and the rules, for example, to play a sequence of media at the occurrence of the triggers.

### CROSS-REFERENCE TO RELATED APPLICATIONS

This application claims the benefit of U.S. Provisional Application No. 61/126,101, filed May 1, 2008.

### FIELD OF THE INVENTION

The present invention generally relates to content presentation and, more particularly, to a method, apparatus and system for the distribution and presentation of select content, such as retail advertising content, based on triggering events.

### BACKGROUND OF THE INVENTION

Traditional content distribution systems are used to provide content to a plurality of end systems. For example, in the advertising realm, providing in-store retail media content is becoming the most popular advertising medium in use today, with broadcast distribution being its primary means of content presentation. That is, in recent years retailers and the managers of public spaces have brought in video display systems for advertising use. In such systems, content is distributed by a server and received at a respective set-top-box for each display or group of displays. Retailers use the displays to present their current offerings or sale information, while the public spaces sell time on the video displays to advertisers either national or local, knowing that large numbers of consumers will see the presentation. Such traditional systems program the playback of content to occur in loops or based on specific timing. Such programmed playback is referred to as playlist-based content presentation.

However, there are drawbacks to the currently available content distribution models, such as those described above. That is, currently, there are no processes, services and/or tools that enable clients of such systems to update scheduled content or replace scheduled content with alternate content based on, for example, changing conditions.

As such, there is thus a need for a new means of content distribution which overcomes the above described deficiencies in the state of the art as well as other related deficiencies and which provides for the integration of product advertising and product availability.

### SUMMARY OF THE INVENTION

Embodiments of the present invention address the deficiencies of the prior art by providing a method, apparatus and system for event-based content distribution.

In one embodiment of the present invention a method for event-based content distribution includes determining at least one triggering event, determining rules for content distribution and in response to the occurrence of at least one of triggering events, causing a distribution of content intended to be distributed in response to the occurrence of the triggering event in accordance with the determined rules for content distribution.

In an alternate embodiment of the present invention, an apparatus for event-based content distribution includes a memory for storing determined triggering events and content distribution rules and a processor configured to, in response to the occurrence of at least one of triggering events, cause a distribution of content intended to be distributed in response to the occurrence of the triggering event in accordance with the determined rules for content distribution.

### BRIEF DESCRIPTION OF THE DRAWINGS

The teachings of the present invention can be readily understood by considering the following detailed description in conjunction with the accompanying drawings, in which:

FIG. 1 depicts a high level block diagram of a content distribution system in which an embodiment of the present invention can be applied;

FIG. 2 depicts a high level block diagram of an in-store advertising network for providing in-store advertising; and

FIG. 3 depicts a flow diagram of a method for event based content distribution in accordance with an embodiment of the present invention.

It should be understood that the drawings are for purposes of illustrating the concepts of the invention and are not necessarily the only possible configuration for illustrating the invention. To facilitate understanding, identical reference numerals have been used, where possible, to designate identical elements that are common to the figures.

### DETAILED DESCRIPTION OF THE INVENTION

The present invention advantageously provides a method, apparatus and system for event-based content distribution. Although the present invention will be described primarily within the context of an in-store product advertising environment having a specific supply chain means, the specific embodiments of the present invention should not be treated as limiting the scope of the invention. It will be appreciated by those skilled in the art and informed by the teachings of the present invention that the concepts of the present invention can be advantageously applied in substantially any content distribution system or product advertising environment for determining the distribution or display of selected content.

The functions of the various elements shown in the figures can be provided through the use of dedicated hardware as well as hardware capable of executing software in association with appropriate software. When provided by a processor, the functions can be provided by a single dedicated processor, by a single shared processor, or by a plurality of individual processors, some of which can be shared. Moreover, explicit use of the term “processor” or “controller” should not be construed to refer exclusively to hardware capable of executing software, and can implicitly include, without limitation, digital signal processor (“DSP”) hardware, read-only memory (“ROM”) for storing software, random access memory (“RAM”), and non-volatile storage. Moreover, all statements herein reciting principles, aspects, and embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure).

Thus, for example, it will be appreciated by those skilled in the art that the block diagrams presented herein represent conceptual views of illustrative system components and/or circuitry embodying the principles of the invention. Similarly, it will be appreciated that any flow charts, flow diagrams, state transition diagrams, pseudocode, and the like represent various processes which can be substantially represented in computer readable media and so executed by a computer or processor, whether or not such computer or processor is explicitly shown.

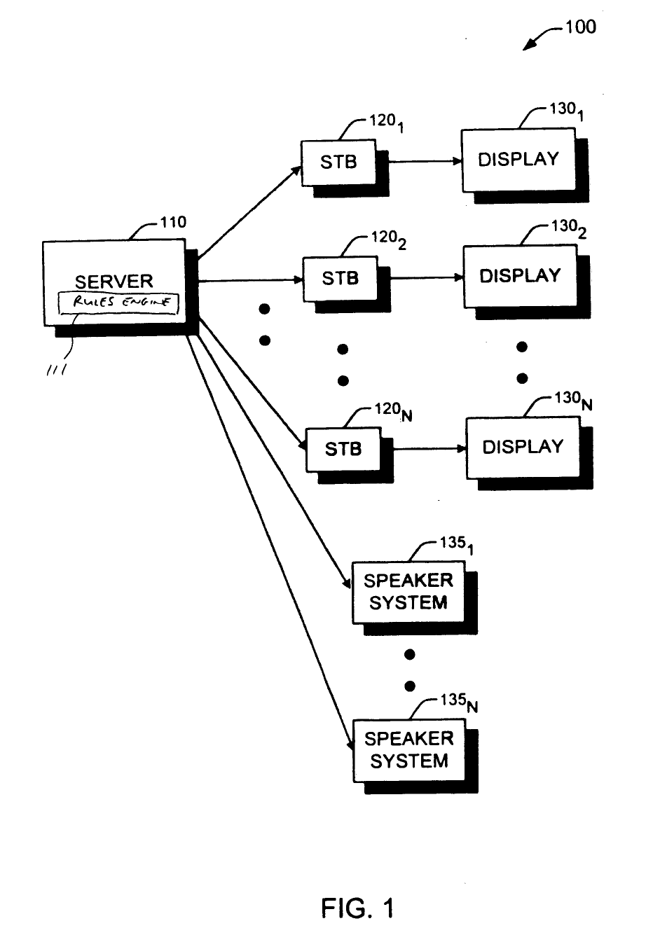

FIG. 1 depicts a high level block diagram of a content distribution system in which an embodiment of the present invention can be applied. The content distribution system 100 of FIG. 1 illustratively comprises at least one server 110, a plurality of receiving devices such as tuning/decoding means (illustratively set-top boxes (STBs)) 120₁-120ₙ, and a respective display 130₁-130ₙ for each of the set-top boxes 120₁-120ₙ, and other receiving devices, such as audio output devices (illustratively speaker systems) 135₁-135ₙ. In the embodiment of FIG. 1, the server 110 illustratively comprises a Rules Engine 111, whose function will be described in detail below.

Although in the system 100 of FIG. 1, each of the plurality of set-top boxes 120₁-120ₙ, is illustratively connected to a single, respective display, in alternate embodiments of the present invention, each of the plurality of set-top boxes 120₁-120ₙ, can be connected to more than a single display. In addition, although in the content distribution system 100 of FIG. 1 the tuning/decoding means are illustratively depicted as set-top boxes 120, in alternate embodiments of the present invention, the tuning/decoding means of the present invention can comprise alternate tuning/decoding means such as a tuning/decoding circuit integrated into the displays 130 or other stand alone tuning/decoding devices and the like. Even further, receiving devices of the present invention can include any devices capable of receiving content such as audio, video and/or audio/video content.

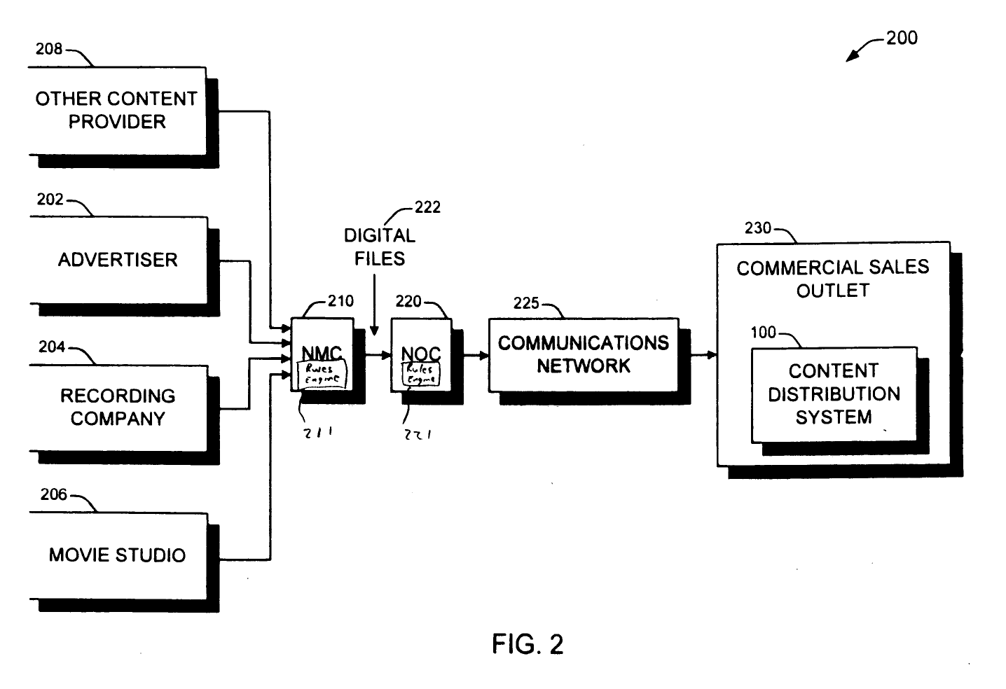

In one embodiment of the present invention, the content distribution system 100 of FIG. 1 can be a part of an in-store advertising network. For example, FIG. 2 depicts a high level block diagram of an in-store advertising network 200 for providing in-store advertising. In the advertising network 200 of FIG. 2, the advertising network 200 and distribution system 100 employ a combination of software and hardware that provides cataloging, distribution, presentation, and usage tracking of music recordings, home video, product demonstrations, advertising content, and other such content, along with entertainment content, news, and similar consumer informational content in an in-store setting. The content can include content presented in compressed or uncompressed video and audio stream format (e.g., MPEG4/MPEG4 Part 10/AVC-H.264, VC-1, Windows Media, etc.), although the present system should not be limited to using only those formats.

In one embodiment of the present invention, software for controlling the various elements of the in-store advertising network 200 and the content distribution system 100 can include a 32-bit operating system using a windowing environment (e.g., MS-Windows™ or X-Windows operating system) and high-performance computing hardware. The advertising network 200 can utilize a distributed architecture and provides centralized content management and distribution control via, in one embodiment, satellite (or other method, e.g., a wide-area network (WAN), the Internet, a series of microwave links, or a similar mechanism) and in-store modules.

As depicted in FIG. 2, the content for the in-store advertising network 200 and the content distribution system 100 can be provided from an advertiser 202, a recording company 204, a movie studio 206 or other content providers 208. An advertiser 202 can be a product manufacturer, a service provider, an advertising company representing a manufacturer or service provider, or other entity. Advertising content from the advertiser 202 can consist of audiovisual content including commercials, “info-mercials”, product information and product demonstrations, and the like.

A recording company 204 can be a record label, music publisher, licensing/publishing entity (e.g., BMI or ASCAP), individual artist, or other such source of music-related content. The recording company 204 provides audiovisual content such as music clips (short segments of recorded music), music video clips, and the like. The movie studio 206 can be a movie studio, a film production company, a publicist, or other source related to the film industry.

The movie studio 106 can provide movie clips, pre-recorded interviews with actors and actresses, movie reviews, “behind-the-scenes” presentations, and similar content.

The other content provider 208 can be any other provider of video, audio or audiovisual content that can be distributed and displayed via, for example, the content distribution system 100 of FIG. 1.

In one embodiment of the present invention, content is procured via the network management center 210 (NMC) using, for example, traditional recorded media (tapes, CD's, videos, and the like). Content provided to the NMC 210 is compiled into a form suitable for distribution to, for example, the local distribution system 100, which distributes and displays the content at a local site. In the embodiment of FIG. 2, the NMC 210 illustratively comprises a Rules Engine 211, whose function will be described in detail below.

The NMC 210 can digitize the received content and provide it to a Network Operations Center (NOC) 220 in the form of digitized data files 222. It will be noted that data files 222, although referred to in terms of digitized content, can also be streaming audio, streaming video, or other such information. The content compiled and received by the NMC 210 can include commercials, bumpers, graphics, audio and the like. All files are preferably named so that they are uniquely identifiable. More specifically, the NMC 210 creates distribution packs that are targeted to specific sites, such as store locations, and delivered to one or more stores on a scheduled or on-demand basis. The distribution packs, if used, contain content that is intended to either replace or enhance existing content already present on-site (unless the site's system is being initialized for the first time, in which case the packages delivered will form the basis of the site's initial content). Alternatively, the files may be compressed and transferred separately, or a streaming compression program of some type employed. In the embodiment of FIG. 2, the NOC 220 also illustratively comprises a Rules Engine 221, whose function will be described in detail below.

The NOC 220 communicates digitized data files 222 to, in this example, the content distribution system 100 at a commercial sales outlet 230 via a communications network 225. The communications network 225 can be implemented in any one of several technologies. For example, in one embodiment of the present invention, a satellite link can be used to distribute digitized data files 222 to the content distribution system 100 of the commercial sales outlet 230. This enables content to easily be distributed by broadcasting (or multicasting) the content to various locations. Alternatively, the Internet can be used to both distribute audiovisual content to and allow feedback from commercial sales outlet 230. Other ways of implementing communications network 225, such as using leased lines, a microwave network, or other such mechanisms can also be used in accordance with alternate embodiments of the present invention.

The server 110 of the content distribution system 100 is capable of receiving content (e.g., distribution packs) and, accordingly, distribute them in-store to the various receivers such as the set-top boxes 120 and displays 130 and the speaker systems 135. That is, at the content distribution system 100, content is received and configured for streaming. The streaming can be performed by one or more servers configured to act together or in concert. The streaming content can include content configured for various different locations or products throughout the sales outlet 230 (e.g., store). For example, respective set-top boxes 120 and displays 130 and various speaker systems 135 can be located at specific locations throughout the sales outlet 230 and respectively configured to display content and broadcast audio pertaining to products located within a predetermined distance from the location of each respective set-top box and display.

The server 110 of the content distribution system 100 receives content and creates various different streams (e.g., content channels) of audio, video and/or audio/video to be communicated to the various receivers throughout the store. The streams can be individual channels of modulated audio, video and/or audio/video onto a radio frequency distribution or transmitted as data flows within a unicast or multicast internet protocol (IP) network. These streams can originate from one or more servers under the same logical set of control software.

The various embodiments of the present invention enable the presentation or distribution of content in, for example, in-store advertising networks, such as the in-store advertising network 100 of FIG. 1, in content distribution systems, such as the content distribution system 200 of FIG. 2, based on triggers or events. In accordance with various embodiments of the present invention, Rules can be determined and implemented for processing the trigger/event. That is, in various embodiments of the present invention, at least one trigger/event is determined and at least one Rule for implementing a respective trigger/event is determined and associated with the respective trigger/event. As such, in response to the occurrence of an event associated with the at least one trigger/event, content intended to be displayed in response to the occurrence of the trigger/event is distributed in accordance with the instructions or parameters of the associated Rule(s).

In accordance with various embodiments of the present invention, a trigger/event can be generated by whatever external sensor or intelligent object desired. Such events carry payloads of data. For example, in one embodiment of the present invention a trigger/event can be a published outside temperature event. The data payload of the event in such an example might be the degrees Fahrenheit measured outside (or communicated by some means such as a weather service). The trigger/event would be detected by a Rules Engine, such as the Rules Engines 111, 211, 221 of FIGS. 1 and 2, and compared to a set of Rules. If a Rule was found with an antecedent that matched the trigger/event (e.g., time, trigger events, set points, etc.) then consequent attributes would be placed into effect (described in further detail, below).

In accordance with the various embodiments of the present invention, a Rules Engine can comprise a processor and memory for storing and/or determining triggers/events and Rules. That is, as described above, in various embodiments of the present invention, triggers/events are determined such that in response to the occurrence of an event associated with at least one determined trigger/event, content intended to be displayed in response to the occurrence of the event is distribute in accordance with a determined, respective Rule. As such, a Rules Engine of the present invention is implemented to detect determined triggers/events in response to inputs from external sensors or intelligent objects intended to inform the Rules Engine of the occurrence of any one of the determined triggers/events. For example, in one embodiment of the present invention, the Rules Engine can comprise a computer receiving inputs from, for example, an internal clock and calendar for keeping track of the date and/or time or from the internet for being informed of temperature or conditions of the determined triggers/events. Although in FIGS. 1 and 2 above the Rules Engine is illustrated as a separate component of the NMC 210, the NOC 220 and the local server 110, in alternate embodiments of the present invention, the Rules Engine can be integrated into the functions of the NMC 210, the NOC 220 and the local server 110.

In various alternate embodiments of the present invention, metadata is added to content to be distributed and displayed. In one embodiment of the present invention, the metadata identifies the type of content. For example for a retail advertising environment, the metadata can identify the content including at least a category of product and a manufacturer for advertised products. As such, because the content can be identified, distributed Rules or locally determined Rules can define and configure triggers that can affect the distribution and display of the identified content.

That is as described above, in accordance with various embodiments of the present invention, a schedule of content to be distributed and played can be configured based on triggers. However, existing Rules can override the content schedule at which point alternate content will have to be substituted for the scheduled content. For example, in accordance with the present invention a piece of content in a trigger-based schedule can be over-ridden by alternate content that is triggered by an event. That is, although content is scheduled to play at a specified time and location, external events can trigger the replacement of the content with alternate content to be played.

For example, in one embodiment of the present invention, a playout system, such as a display 130 or audio output device 135 of FIG. 1, receives triggering or override information for a specific content schedule from at least one of the network management center 210, the network operations center 221 or from a user interface in communication with the local server 110. The triggering and override information can further include media clips or portions intended to replace specific media portions that are scheduled to play if a triggering event occurs.

Examples of external events or triggering events can include the following:
if the temperature outside the store is greater than 80F play media Y instead of media X
if a customer is detected near display N play media A instead of media B
if the price of a product for which media is available drops play a modified version of the media to denote the price decrease.
if more women than men are in the store, play media X instead of Y

Other examples can include:
if it is a Tuesday, play A instead of B
if a certain team wins a championship game, play media X
if a certain media is deemed ineffective, play media Y instead.
   As described above, however, content to be presented in response to a triggering event can also be subject to Rules. For example, in the event that if the temperature outside the store is greater than 80F and media Y is to be played instead of media X, if most previously played piece of content was an advertisement for a competing product to media Y, then media Y may not be allowed to be displayed until after other media is displayed.

In various embodiments of the present invention, the triggering of the present invention can be automatic based on events as they occur, or the triggering of the present invention can be dynamically scheduled locally via a user interface. That is, the triggering events can be created at and/or communicated from a central programming control system, for example at the network management center 210, the network operations center 220, or the server 110 or several programming control systems (e.g., interfaces) driven by, for example, local users using user interfaces, a network operator, an advertiser, a media provider, a venue owner (such as retailer), and a consumer with access to the playout system. In such embodiments, a venue owner can enable central personnel or local personnel to schedule triggering events and changes based on local needs versus the needs of multiple playout system locations or a centralized network.

As described above, in various embodiments of the present invention, Rules can include consequent attributes. For example, exemplary Rules can include at least one the following consequent attributes:
Target Playback Device(s)
Target Playback Object(s)
Operation(s)
Priority
Date-Time Range of applicability

The consequent attributes can define and limit the scope of a Rules' applicability to, for example, a subset of playback devices in, for example, a retail store by specifying target playback device(s). Such devices can be grouped into sets (sometimes called a channel) or enumerated. In an embodiment of the present invention, an associated mapping of playback devices to channels or groups can be used by the Rules Engine to match and apply Rules.

In accordance with various embodiments of the present invention, a consequent attribute can create new rules, can make specific changes to playback objects, or can create new playback objects. Playback objects can be represented by (but not limited to) Programs, Playlists, and Media elements. One other media object might be a ‘live broadcast’ where the media is obtained in real-time from some broadcast provider. Each of these objects has a unique identifier that can be used with Rules to unambiguously identify the object.

In alternate embodiments of the present invention, ‘wildcards’ can be implemented to apply to a set of possible media objects that have yet to be defined. In various embodiments of the present invention, the object can be represented in a file, in memory, in a database, or any similar logical structure.

In various embodiments of the present invention, the functional operation(s) of a Rule can include but are not limited to:
Play
Don't Play
Swap

For example, the Play operation can designate that a Playback object is to be played. An example of such a Rule can be derived from traditional scheduled (playlist) playback. Traditional playback can operate by following a schedule file to deduce when certain media or playlists are to occur. In accordance with embodiments of the present invention, however, a Rule can trigger a media object (content) to be displayed at a desired date-time and the operation can ‘play’ on that object (playlist). As such and in accordance with an embodiment of the present invention, a new Rule can be created that would trigger that same playback at some time other than the planned time—in reaction to some event for example.

In various embodiments of the present invention, “don't play” operators are essentially “skip” operators. These consequent attributes have the effect of causing the media object to be skipped as if it did not exist.

Swap operators cause a media object (or set of objects) to be replaced by some other object or objects. An example can be to play one media file instead of another media file. A more complex example of this would be a ‘special event’ kind of operation that would cause an entire program or playlist to be used instead of another one. One implementation of this would be to play a live broadcast instead of the scheduled programming.

In addition, in various embodiments of the present invention, Rules can further contain priorities. In such embodiments of the present invention, the priority can be an integer value that ranks the importance of the Rule. For example, in several embodiments, higher priority rules will have preference over lower priority rules. This provides a means to resolve conflicts when multiple Rules are processed with the same antecedents.

In embodiments of the present invention, Rules can be defined statically or dynamically. One embodiment of an implementation of the Rules of the present invention can use XML. Such Rules can be stored in data files on a file system or communicated via a network web service means such as RPC, REST, or SOAP. In addition, in alternate embodiments of the present invention, a trigger event can be expressed as a matching pattern with the set-point expressed appropriately. Examples can include regular expressions or ‘crontab’ style matching templates. In such embodiments, this can be one way to express Rules that apply to a specific day of the week, hour of the day, etc. It should be noted, however, that these are not the only mechanisms for triggers but are examples of ways triggers can be described in accordance with various embodiments of the present invention.

### Rules and Dynamic Selection

The rules of the present invention can additionally apply to a local server, such as a content server, in which a portion of the system that is preparing a media element for playback can make a query to the content server for media to play. In this scenario the Rules processing discussed above can apply and it is possible that a pool of media can be resolved as possible playback choices. In one application of a content server of the present invention, the content server can randomize the choice selected from that pool or apply similar Rules to narrow selection in a second processing step. The content server can create new Rules based on the media selected to affect subsequent request processing. For example, there can be rules that detail adjacency. In this embodiment, a Rule can be created that limits what media could play after the current selected media (i.e., competing product ads should not play back to back (e.g., Coke and Pepsi)).

### Meta-Data Tags on Media Objects

In various embodiments of the present invention, media objects (content) are tagged with meta-data. In the example above, the Pepsi and Coke ads can be tagged with key value pair data such as “ProductName=Pepsi” and “ProductType=”drink”. In one embodiment of the present invention, a Rule that can apply to this case can include “if the ProductType of the last selected media matches the current proposed selected media and the ProductName is different then reject that media object and choose again.” This is only one example of how the Rules of the present invention can be constructed.

### Rules and Dynamic Media

In accordance with various embodiments of the present invention, Rules can also be specified for the availability of media to be assembled as components into a larger element. For example, in one embodiment of the invention, a media playback engine (e.g., a playout device) can request a template from the content server. An appropriate template is selected via Rules processing. The template can detail several regions and call out desired media types for the playback engines. The media playback engine can then request media from the content server for each region, triggering a Rules processing step for each region. Each selection can create new Rules that ultimately limits the selection to specific media content. In this case, Rules would use metadata tags that identify attributes of the media such as size, media encoding type, etc. In one embodiment of the invention, this can be accomplished by using a SMIL template and populating it with MPEG, JPEG, HTML, and scrolling text data selected from the Ad Server.

### Rules and Actions

In accordance with an embodiment of the present invention, Rules can trigger other actions as well that are not related to media playback. For example, a Rule can generate an event that in turn is logged or controls some other aspect of the system. In one embodiment of a system of the present invention, this can trigger special audio processing effects or lighting effects to enhance the advertising effects. It should be noted that the embodiments of the present invention should not be limited to Rules having an effect only on select video content.

### Dynamic Composition

As described above, Rules can trigger other actions as well that are not related to the content playback. In a particular embodiment of the present invention, a set of requests and responses to the content server can result in a new Rule that triggers an event that causes the selection of media content into a composite media used in, for example, advertising. In one example, the static elements can be selected to fill a template and then converted to a video file for use. In accordance with various embodiments of the present invention, Rules not only affect the selection of select content for playback at run time but also can control the functionality of an entire content distribution system.

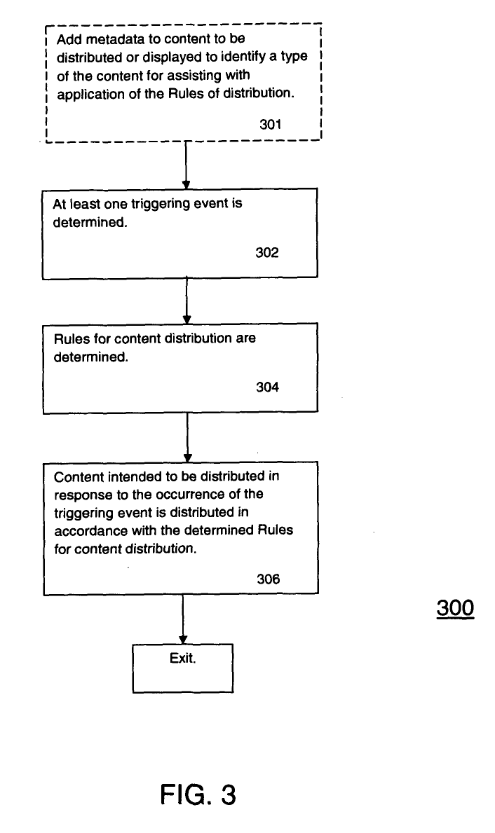

FIG. 3 depicts a flow diagram of a method for event based content distribution in accordance with an embodiment of the present invention. The method 300 begins at step 302, in which at least one triggering event is determined. For example, in one embodiment of the present invention triggering events can be determined by or stored in the Rules Engine 111, 211, 221, which is implemented for determining when a triggering event has occurred. The method 300 then proceeds to step 304.

At step 304, Rules for content distribution are determined. For example, as described above, Rules are associated with content distribution such that content intended to be distributed can be played, skipped or replaced with other content. The method 300 then proceeds to step 306.

At step 306, content intended to be distributed in response to the occurrence of the triggering event is distributed in accordance with the determined Rules for content distribution. For example, when a triggering event has occurred, content intended to be distributed in response to the occurrence of the triggering event is distributed only if a Rule associated with the distribution of that content does not prevent or substitute the distribution of that content as described above. The method 300 can then be exited.

Alternatively, method 300 can include optional step 301 at which metadata is added to content to be distributed or displayed to identify a type of the content for assisting with application of the Rules of distribution.

It should be noted that the use of the term “display” throughout the teachings of this disclosure should not be considered as being limited to the presentation of video, but can be representative of either the presentation of video on, for example, a display or the presentation of audio on, for example, a speaker and/or both on an integrated device. In addition, it should be noted that the term “media content” and/or “media portion” and/or “media clip” used throughout the teachings of this disclosure can be used to identify media content including video portions, audio portions and/or both.

Having described various embodiments for a method, apparatus and system for the distribution and presentation of select content, such as retail advertising content, based on triggering events (which are intended to be illustrative and not limiting), it is noted that modifications and variations can be made by persons skilled in the art in light of the above teachings. It is therefore to be understood that changes can be made in the particular embodiments of the invention disclosed which are within the scope and spirit of the invention as outlined by the appended claims. While the forgoing is directed to various embodiments of the present invention, other and further embodiments of the invention can be devised without departing from the basic scope thereof.

1. A method for event-based content distribution, comprising:
determining at least one triggering event;
determining rules for content distribution; and
in response to the occurrence of at least one of said at least one triggering events, causing a distribution of content intended to be distributed in response to the occurrence of said at least one triggering event in accordance with the determined rules for content distribution.

2. The method of claim 1, wherein along with said at least one triggering event, information identifying content to be distributed in response to a triggering event is also determined.

3. The method of claim 2, wherein identified content to be distributed in response to a triggering event replaces regularly scheduled content.

4. The method of claim 1, further comprising adding metadata to content to identify content.

5. The method of claim 1, wherein said content comprises retail advertising content, which upon the occurrence of a triggering event, is displayed on a display in a retail advertising environment.

6. The method of claim 1, wherein said determined rules identify replacement content to be distributed in lieu of content originally intended to be distributed in response to the occurrence of a triggering event.

7. An apparatus for event-based content distribution, comprising:
a memory for storing determined triggering events and content distribution rules; and
a processor configured to:
in response to the occurrence of at least one of the stored triggering events, cause a distribution of content intended to be distributed in response to the occurrence of the triggering event in accordance with the determined rules for content distribution.

8. The apparatus of claim 7, further comprising:
a means for detecting the occurrence of at least one triggering event.

9. The apparatus of claim 8, wherein said apparatus receives information used to determine the occurrence of triggering events from an external source.

10. A method for event-based content distribution, comprising:
in response to the occurrence of at least one triggering event, causing a distribution of content intended to be distributed in response to the occurrence of said at least one triggering event in accordance with determined rules for content distribution.

11. The method of claim 10, wherein content is scheduled for distribution in accordance with an events-based playlist.

12. The method of claim 10, further comprising adding metadata to content to identify content.
